(19) United States
(12) Patent Application Publication
(10) Pub. No.: US 2015/0030762 A1
(43) Pub. Date: Jan. 29, 2015

(54) NON-BROMINE AND NON-ANTIMONY COMPOSITIONS FOR LOW FLAME AND LOW SMOKE POLYVINYL CHLORIDE COMPOUNDS AND CONSTRUCTIONS

(71) Applicants: James F. Day, Winston-Salem, NC (US); Veerag Mehta, Monroe Township, NJ (US)

(72) Inventors: James F. Day, Winston-Salem, NC (US); Veerag Mehta, Monroe Township, NJ (US)

(21) Appl. No.: 14/445,173

(22) Filed: Jul. 29, 2014

Related U.S. Application Data
(60) Provisional application No. 61/859,474, filed on Jul. 29, 2013.

(51) Int. Cl. H01B 3/44; H01B 19/04; H01B 7/295

(52) U.S. Cl. CPC H01B 3/443; H01B 7/295; H01B 19/04
USPC 427/117; 524/567

(57) ABSTRACT

Materials for making bromine- and antimony-free polyvinyl chloride (PVC) compounds and constructions that have low flame and smoke properties as well as low brittleness properties. The compositions are especially useful for making cable jackets, particularly riser and plenum cables. The compositions contain PVC resins, plasticizers, non-brominated flame retardants, fillers and stabilizers, and optionally smoke suppressants.

This application is a utility application claiming priority from D.S. Provisional Patent application Ser. No. 61/859,474, filed on Jul. 29, 2013.

### BACKGROUND OF THE INVENTION

The present invention relates to PVC compositions and constructions free of bromine flame retardants and free of antimony synergists. These compositions are particularly useful for making cable jackets especially for riser and cable jackets that have low flammability and smoke properties and allow the cable to meet UL910 or NFPA-262 or UL1666 specifications.

The present invention is useful in a variety of PVC constructions that specify low flammability and/or smoke requirements such as construction, electrical and electronic applications, as well as, aerospace and automotive materials.

Polyvinyl chloride (PVC) is used in a wide variety of compositions and constructions that have low flammability and smoke requirements. These compositions are particularly useful in wire and cable applications.

Buildings are usually designed with a space between a drop ceiling and a structural floor from which the ceiling is suspended to serve as a return air plenum for elements of heating and cooling as well as a convenient location for communications cables and other equipment, power cables and data cables. Such data cables are called plenum cables. Alternatively, the building may employ raised floors providing an area for cable routing and plenum space. Communications continuous throughout the length and width of each floor and these cables may introduce safety hazards, both to the cables and the buildings.

When a fire occurs in an area between a floor and a drop ceiling, it may be contained by walls and other building elements which enclose the area. However, if and when the fire reaches the plenum space, and especially if flammable materials occupy the plenum, the fire can quickly spread throughout the entire floor of the building. The fire can travel along the length of cables which are installed in the plenum if the cables are not rated for plenum usage, e.g. not specified with the requisite flame and smoke resistance properties. Also, smoke can be conveyed through the plenum to adjacent areas and to other floors with the possibility of smoke permeation throughout the entire building.

As the temperature in a non-plenum rated jacketed cable rises, charring of the jacket material begins. Afterwards, the conductor insulation inside the jacket begins to decompose and char. If the charred jacket retains its integrity, it still functions to insulate the core; however, if it ruptures due either to expanding insulation char or to the pressure of gases generated from the insulation, and as a consequence, exposes the interior of the jacket and insulation to the flame and/or the elevated temperatures. The jacket and insulation begin to pyrolyze and emit more flammable gases. These gases ignite and, because of the air drafts in the plenum, burn beyond the area of flame impingement, thereby propagating flame through the building and generating smoke and toxic gases.

Because of the possibility of flame spread and smoke evolution, the National Electrical Code (NEC) requires that power-limited cables in plenums be enclosed in metal conduits. The NEC permits certain exceptions to this requirement. For example, cables not enclosed in metal conduits, provided that such cables are tested and approved by an independent testing agent, such as Underwriters Laboratories (UL), with suitably low flame spread and smoke generating or producing properties. The flame spread and smoke production of cables are measures using the UL910 (NEC 1998 edition) or NFPA-262 (NEC 2011 edition). This testing, also known as the “Steiner Tunnel Test,” is the standard method for fire and smoke resistance properties of electrical and optical fiber cables in the plenums.

A riser (CMR) rated cable is a cable that meets the UL1666 (NEC 2007 edition) requirements. These cables are designed for installations in vertical trays between floors and through elevator shafts. The cable typically contains twisted, insulated wires and jacketed with a riser-type jacket. The most important property of a CMR jacket is to pass the UL1666 vertical burn test. In this test, finished cables are placed in a chamber and exposed to a continuous flame (at 154.5 KW) for 30 minutes. To pass this test, the flame propagation cannot equal or exceed 12 feet beyond the ignition point, and temperatures cannot exceed 850° F.

One of the main obstacles to developing a polyvinyl chloride (PVC) jacket composition to pass the UL1666 or NFPA-262 or UL1666 specifications is to maintain low flammability and smoke evolution. To do so, formulators tend to add a significant amount of bromine (in the form of brominated phthalates) and antimony synergists. These additives are costly and are underdoing environmental scrutiny, especially the brominated phthalate, a brominated analogue of bis (2-ethylhexyl) phthalate.

Epidemiologic studies have also evaluated the human health impacts of phthalate exposure. These studies have identified a possible association between exposure to phthalates and male reproductive malformation, sperm damage, fertility impairment, female reproductive tract diseases, early puberty in girls, asthma, and thyroid effects. Adverse effects on the lungs, liver and kidneys have been observed in animals and in some limited human studies. Phthalates may also pose risks for aquatic and terrestrial ecosystems particularly in the vicinity of phthalate processing industries. Some phthalates are bio-accumulative and have been detected in aquatic organisms. Brominated phthalate has been detected in surface waters.

Antimony compounds are also under scrutiny. Everyone is exposed to low levels of antimony in the environment. Acute (short-term) exposure to antimony by inhalation in humans results in effects on the skin and eyes. Respiratory effects, such as inflammation of the lungs, chronic bronchitis, and chronic emphysema, are the primary effects noted from chronic (long-term) exposure to antimony in humans via inhalation. Human studies are inconclusive regarding antimony exposure and cancer, while animal studies have reported lung tumors in rats exposed to antimony trioxide via inhalation. EPA has not classified antimony for carcinogenicity. The purpose of this invention is the use of an organo-functional silicon additive in place of the brominated phthalate and antimony in polyvinyl chloride compounds and constructions. This invention is particularly useful in wire and cable applications.

### THE INVENTION

The present invention provides composition's wherein the brominated phthalate plasticizer and/or antimony can be replaced with an organo functional silicon or similar type additive for polyvinyl chloride (PVC) compositions and constructions. These compositions are especially useful for in jackets or insulation for riser cables passing UL1666 and plenum cables passing UL910 or NFPA-262 tests.

Additionally, the present invention provides method for making PVC compounds for plenum or riser cables that meet UL910 and/or NFPA-262. These compounds are made by mixing a PVC resin with plasticizer, fillers, stabilizers and the organo functional silicon additive. The compounds can be used to insulate at least one conductor or insulated wires in the form of a jacket. Preferably, the jacket is formed by extrusion.

Further, the present invention can be utilised as the neat additive or with a carrier. The carrier can be PVC or other polymers compatible with PVC.

### DETAILED DESCRIPTION OF THE INVENTION

Polyvinyl chloride (PVC) resins that are appropriate for the present invention are medium or high molecular weight, general purpose vinyl suspension resins. Such PVC resins are well known in the art and are commercially available from a number of sources. The PVC resin is preferably present in the composition, by weight, from about 30% to about 50%.

The present invention does not contain a brominated phthalate, which is well known in polymer processing. The replacement is an organo functional silicon additive available as DynaSil™ FR from Polymer Dynamix, LLC in South Plainfield, N.J. Other types of organo-silicon-based additives may also be useful as a replacement for DynaSil™ FR from Polymer Dynamix, LLC. This additive is typically present from 1% to 30%.

Plasticizers are well known in the art and are added to improve its flexibility and processing properties. Plasticizers appropriate for the present invention include, but are not limited to, phthalates, trimellitates, sebacates, benzoates, azelates, adipates, succinates, pentaerythritol esters, and polymeric plasticizers that are known in the art.

The compositions may contain fillers that are well known in the art, for example, alumina trihydrate, magnesium hydroxide, magnesium or calcium carbonate, talcs, clays, silicates, and the like. The remainder of the composition may contain other additives such a stabilizers, lubricants, anti-oxidants and smoke suppressants, including molybdenum, zinc and/or antimony compounds, and drip suppressants such as PTFE.

All of the materials of the compositions utilized in the instant invention are usually blended or compounded together prior to their introduction into an extrusion device from which they are extruded as compound and later applied by an extrusion process as insulation on conductors or as a jacket of insulated conductors. This process can be combined in a continuous operation, e.g. compounding and directly extruding as insulation over conductors and/or the cable jacket. The polymer and the other additives and filler may be blended together by any of the techniques used in the art to blend and compound such mixtures to homogeneous masses. For example, the components may be fluxed on a variety of equipment including, but not limited to, multi-roll mills, screw mills, continuous mixers, compounding extruders and Banbury mixers.

After the various materials of the compound are uniformly mixed and blended together, they are further processed to manufacture wire and cable components. Prior art methods for forming these compounds into insulation over conductors and/or jackets are well known, and the fabrication of the cables may generally be accomplished using any of the various extrusion techniques.

The compounds of the instant invention, when used in PVC materials, particularly in wire and cable applications, give surprisingly less flammability and lower smoke generation, without the use of brominated phthalates and/or antimony compounds. As such, these expensive materials can be eliminated or reduced from the inventive composition.

Without further description, it is believed that one of ordinary skill in the art can, using the preceding description and the following illustrative examples, manufacture and apply the present invention in various polyvinyl chloride compounds. The following examples are given to illustrate the present invention. It should be understood that this invention is not limited to the specific conditions or details described in these examples. It should be understood that this invention is not limited to the specific conditions or details described, but can be utilised in a wide variety of materials and constructions based on polyvinyl chloride, such as, but not limited to, wire and cable, wall coverings, construction products, and so forth.

### EXAMPLES

In these examples, the compounds were mixed by a kneader, extruder, or rotary batch mixture. These compounds can be applied as insulation to conductors and/or jackets by extrusion. The prepared compounds were extruded to a die attached to an extruder. Plaques were pressed in a heated press.

Examples of ingredients and proportions are shown in the following tables.

TABLE 1
PVC FORMULATIONS

| Ingredient | Control 1 | Control 2 | Test A | Test B |
|---|---|---|---|---|
| PVC Resin | 46.382 | 51.02 | 39.426 | 40.817 |
| Calcium Zinc | 2.319 | 2.319 | 2.319 | 2.319 |
| Stabilizer | | | | |
| Alumina Trihydrate | 25.510 | 25.510 | 25.510 | 25.510 |
| Magnesium Hydroxide | 2.319 | 2.319 | 2.319 | 2.319 |
| Ammonium | 4.638 | 0.000 | 4.638 | 4.638 |
| Octamolybdate | | | | |
| Stearic Acid | 0.139 | 0.139 | 0.139 | 0.139 |
| Calcium Stearate | 0.139 | 0.139 | 0.139 | 0.139 |
| Antimony Trioxide | 1.391 | 1.391 | 0.000 | 1.391 |
| Trimellitate Plasticizer | 11.596 | 11.596 | 11.596 | 11.596 |
| Brominated Phthalate | 5.566 | 5.566 | 0.000 | 0.000 |
| DynaSil FR 5850N2 | 0.000 | 0.000 | 13.914 | 11.132 |

TABLE 2
TESTING RESULTS FROM TABLE 1 COMPOSITIONS

| Test | Control 1 | Control 2 | Test A | Test B |
|---|---|---|---|---|
| Impact Strength | 2.276 | 2.861 | 4.348 | 3.277 |
| (ft-lb/in) | | | | |
| Tensile Stress at Yield | 2288 | 2769 | 1658 | 1839 |
| Tensile Strain at Yield | 7 | 81.3 | 46.1 | 48.9 |
| (%) | | | | |
| Tensile Stress at | 2155 | 2542 | 1386 | 1587 |
| Break (psi) | | | | |
| Tensile Strain at | 74.9 | 93.9 | 63.1 | 69.9 |
| Break (psi) | | | | |
| Flex Modulus (psi) | 90393 | 96701 | 48583 | 58121 |
| Flexure Stress at 5% | 2801 | 3008 | 1581 | 1964 |
| Deflection (PSI) | | | | |
| LOI (%) | 47 | 47 | 42 | 46 |
| Brittleness (° C.) | | | | |
| Elongation at Break | | | | |
| Tensile Strength (psi) | | | | |
| Durometer | | | | |

While the present invention has been described and illustrated by reference to particular embodiments thereof. It will be appreciated by those of ordinary skill in the art that the invention lends itself to variations not necessarily illustrated herein. For this reason, then, reference should be made solely to the appended claims for the purposes of determining the true scope of the present invention.

What is claimed is:

1. A composition of matter, said composition of matter comprising:
A. at least an extrudable polyvinyl chloride resin, and
B. at least an organofunctional silicon additive.

2. A composition of matter as claimed in claim 1 wherein A. is present in the range of from 30 to 50 weight percent and B. is present in the range of from 1 to 30 weight percent, based on the weight of the total composition.

3. A method of preparing a composition of matter as claimed in claim 1, said method comprising blending and compounding the components together prior to introduction into an extrusion device.

4. A method of providing an insulated jacketed cable, said method comprising:
providing a composition as claimed in claim 3, and
extruding said composition on conducting cable by an extrusion process.
